(19) United States
(12) Patent Application Publication
(10) Pub. No.: US 2005/0213125 A1
(43) Pub. Date: Sep. 29, 2005

(54) Method of color accentuation with compensation and adjustment

(75) Inventors: Paul Reed Smith, Stevensville, MD (US); Gary E. Gilbert, Elkridge, MD (US); Ted Sabety, New York, NY (US)

Correspondence Address: BARNES & THORNBURG, 750-17TH STREET NW, SUITE 900, WASHINGTON, DC, 20006, US

(73) Assignee: Paul Reed Smith Guitars, Limited Partnership

(21) Appl. No.: 11/060,294

(22) Filed: Feb. 18, 2005

Related U.S. Application Data
(63) Continuation of application No. PCT/US03/25692, filed on Aug. 18, 2003.
(63) Continuation of application No. PCT/US04/05640, filed on Feb. 26, 2004.
(60) Provisional application No. 60/404,156, filed on Aug. 19, 2002.
(60) Provisional application No. 60/413,544, filed on Sep. 26, 2002.
(60) Provisional application No. 60/418,190, filed on Oct. 15, 2002.
(60) Provisional application No. 60/449,867, filed on Feb. 27, 2003.

(51) Int. Cl. H04N 1/60; G09G 5/02

(52) U.S. Cl. 358/1.9; 358/518; 345/589

(57) ABSTRACT

The color accentuation method determines the relative magnitude of each color component in each pixel or area. It selects and adjusts the magnitude of one or more of the colors as a function of the determined relative magnitudes of each color component. The type and amount of the adjustment is a function of the relative magnitude differences. One or more of the magnitudes is adjusted to change the relative magnitudes. Typically, the difference in a subtractive color space is between the lowest and middle magnitude color and in an additive color space is between the highest and the middle magnitude color. Also, typically, the lowest color component is reduced in the subtractive color space and the highest is increased in the additive color space. Various scaling functions and compensations or adjustments of the color accentuation may be used.

### CROSS REFERENCE

This application is a continuation of PCT/US03/25692 filed Aug. 18, 2003, which claims benefit of U.S. provisional applications: 60/404,156 filed Aug. 19, 2002, 60/413,544 filed Sep. 26, 2002 and 60/418,190 filed Oct. 10, 2002; and is a continuation of PCT/US04/5640 filed Feb. 26, 2004, which claims benefit of U.S. provisional application 60/449,867 filed Feb. 27, 2003 and priority to: PCT/03/25692 filed Aug. 18, 2003 and U.S. application Ser. No. 10/362,198 filed Feb. 19, 2003 which a 371 of PCT/US01/25654 filed Aug. 17, 2001 which claims benefit of U.S. provisional application 60/226,009 filed Aug. 18, 200, and all of which are incorporated herein by reference.

### BACKGROUND AND SUMMARY OF THE INVENTION

The present invention relates generally to color processing systems and more specifically to a color accentuation system and a component of a color processing system.

Color processing falls into two general categories, namely light projections or displays which are known as additive color systems and pigment or printing systems which are known as subtractive color systems. Color correction systems have been developed to correct for errors in the reader or scanner of the original material, signal transmission or limitations of the display or printing process. In the printing process, the correction can be directed to ink migration and physical color discontinuity. In an image or a video display, color correction can be for errors in the processing system and/or for changing the quality or color of the picture to meet certain criteria and/or tastes.

Examples of prior art systems include U.S. Pat. Nos. 4,674,963; 5,883,984; 6,053,609; 6,057,931 and 6,097,501.

In video and television, there are continuous developments of new formats. The present color accentuation system will help improve digital cameras, TV and other video display devices, video recording devices, and HDTV picture quality in both large and small formats. It will also improve color image printing. Digital still cameras and digital video cameras may have a button or command that triggers various levels of accentuation that would improve the picture quality. For example, one might take a picture on a dull, overcast day. When the accentuation button is pressed, the image will look like it was taken on a bright day. In another example, pictures taken with florescent lighting will look as if they were taken with more natural light.

The present invention is directed to the concept of accentuating the ultimate color image to be more vivid, color diverse, interesting to the eye and having higher color contrast. The present invention would be compatible with almost any video or print media. This patent description translates well to the CMYK color space, which is the system generally associated with the printing industry. CMYK stands for Cyan, Magenta, Yellow, and Black. These colors are related to the primary colors, red, yellow and blue, with black being considered by this invention as the absence of color. TV's and video use the RGB (Red, Green, and Blue) and Y Cb Cr and its related color spaces. The color accentuation system described herein can be converted into any known or new color space or system, whether additive (light) or subtractive (ink, paint, etc.) using well-known algebraic transformations. In addition, in some additive color spaces, the same equations can be used if certain adjustments are made to mitigate for the fact that the color components in some of these color spaces are very different hues from the primary colors. This approach achieves the benefit of the invention, with computational efficiency at the sacrifice of precision, which may be an acceptable trade off in some applications.

The primary colors are red, yellow, and blue. Rainbow colors are generally considered the vivid, bright colors and are either a primary color or two primary colors mixed at some ratio/percentage. In a subtractive primary color space or process, as the percentage of the lowest percentage third color component increases, the overall color becomes more dirty and eventually becomes shades of grays and/or browns. This directly relates to additive color processes and spaces through color space conversion.

The system determines the relative magnitude of each color component. The color components are the set of colors that are the axes in a given color space. In Red, Blue, Yellow, RBY (the primary color space), R, B and Y are the color components. The invention selects and adjusts the magnitude of one or more of the colors as a function of the determined relative magnitudes of each color component. The type and amount of the adjustment is a function of the relative magnitude differences. One or more of the magnitudes is adjusted to change the relative magnitudes. Typically, the difference in a subtractive color space (e.g., CMY(K)) is between the lowest and middle magnitude color and in an additive color space (RGB) is between the highest and the middle magnitude color. Also, typically, the lowest color component is reduced in the subtractive color space, and the highest color component is increased in the additive color space. No adjustment is made if only two colors are present in the area or pixel being investigated. In CMY(K), black (K) is not considered a color in the initial accentuation step.

The invention can be applied to an image on a pixel by pixel basis (where the accentuation function is calculated and applied to each pixel individually) or on an area by area basis (where the function is calculated for an area of the image and the same function applied to each pixel in the area). An area in an image is a set of adjacent pixels in the image that have substantially the same color, in other words, substantially the same color component magnitudes. A practitioner of ordinary skill will recognize that the benefit of the invention can be attained by determining the accentuation function once for all the pixels in an area because the adjacent pixels have substantially the same color component magnitudes.

Scaling functions and compensations may also be used. These include brightness compensation, whiteness compensation, scale-back or scaling compensation and saturation compensation or adjustments using various scaling functions. This may include two color component accentuation or adjustment.

Other objects, advantages and novel features of the present invention will become apparent from the following detailed description of the invention when considered in conjunction with the accompanying drawings.

### BRIEF DESCRIPTION OF THE DRAWINGS

FIG. 1 is a color processing system in which the present invention can be incorporated.

FIG. 2 is a subtractive space color wheel.

FIG. 3 is a single slice color wheel for RYB from color pipe of FIG. 5 with scaling functions.

FIG. 4 is a look up table in CMYK correlating the original to the accentuated color.

FIG. 5 is a conceptual view of the color pipe.

FIG. 6 is a flow chart of color accentuation according to the principles of the present invention.

FIG. 7 shows graphs of a scaling function and its components incorporating the principles of the present invention.

FIG. 8 shows graphs of various scaling functions incorporating the principles of the present invention.

FIG. 9 shows graphs of additional scaling functions incorporating the principles of the present inventions.

FIG. 10 is a conceptual view of the whiteness of a color pipe.

### DETAILED DESCRIPTION OF THE PREFERRED EMBODIMENTS

The core of this invention is developed from the primary colors (Red, Yellow, Blue). However, the system functions in both additive and subtractive color spaces through mathematical color-space transforms.

The present invention can be used in two modes. In a first mode, an image, that is encoded using any first color space, is converted into the color component magnitudes of a second color space and has the accentuation function applied in that color space. The resulting image can be converted back to the original color space. Alternatively in a second mode, the accentuation function can be determined in a first color space and then the accentuation function is transformed to any other color space so that an image need not be converted—the transformed function is applied to the image in the color space of the image. It is also possible to approximate the calculation in such a way that the image and scaling function is not entirely transformed into another color space, but parts of the algebraic transformation are used to calculate intermediate results that provide a close approximation of the invention.

By this means, a practitioner of ordinary skill will recognize that either of these modes is theoretically equivalent, but the second choice is preferred so that data loss by transforming the image in and out of a primary color space (due to numerical rounding and the like) is avoided. Although transformations exist between most color spaces, they are not always perfect, and some loss of color information can take place when converting to and from color spaces. Although the invention can be equivalently used in any color space, the use of the color black in some color space schemes requires special attention. The use of scaling functions and adjustment of scaling function coefficients can mitigate these color distortions.

RYB, the primary color space, is the ideal color space and will be used to explain the concept of the invention.

Since RYB is not presently available in a typical system, the invention will be explained also with respect to CMY and RGB (RGB being used in video applications and which is also an additive color space). CMY(K) (a subtractive color space) is used as the color space for an embodiment of this system because it is a commonly used subtractive color space. The RGB and CMY(K) color spaces have known direct mathematical relationships to each other. However, because the magenta in the CMYK color space has a small blue component, operations on magenta affect two colors (red and blue), not one (red).

The present system looks at the relative differences between the colors and makes the correction based on a function. In CMYK, K, the black, is not adjusted in the initial function. But black may still be part of the color percentage, so that the conversion of CMYK to another color space is accurate. Note that the conversion of RGB to CMY does not include the black component. When all three colors CMY are substantially equal in color, they are “dirty” in color. As the differences in percentage between the colors becomes larger, the higher magnitude perceived primary colors become more dominant. The lowest magnitude value color component of the three colors creates, in the combination the other two colors, a pastel dirtiness, grayness, brown-ness or a perceived lack of contrast, vividness or perceived sharpness. The present invention creates a higher color contrast, sharper, clearer picture or color and reduces the effect of the lower of the three color components, pixel by pixel or area by area. Note that the accentuation adjustment may be to one or more of the three colors.

An overview of the accentuation process is illustrated in FIG. 6. A color space component (CSC) is provided at 30. Depending upon the type of color space being additive or subtractive at 32, the accentuation process is applied in at least one of two ways. The relative magnitude of the color components is determined at 34a or 34b. The relative magnitude determination at 34 may be a single step and may be performed before the determination of the type of color space at 32. In a device including the program of the method, the color space is pre-defined, and the method would include only one leg 34-42. If it is an additive color space, the difference between the MAX and MID is determined at 36a. If it is a subtractive color space, the difference between the MID and the MIN is determined at 36b. These differences are used at 40a and 40b, respectively, to modify the color components as a function of these differences. The output is provided as a new color space component (CSCnew) at 44.

As will be described, various scaling functions 38a or 38b may be used in modifying the color components, as well as various compensations at 42a or 42b. The compensation at 42a and 42b may be part of the color component modification 40a and 40b or may be a post-process modification. The selection of scaling may precede the steps of 34, 36 or 40 and may be incorporated as part of step 40. In the determining the relative magnitude of the color components, it may require normalizing the color component value ranges in cases where the color components do not have the same numerical range.

Depending upon the system and the color space components, the color space components may be converted to a different color space using the previously developed modified color component as a function of the differences, or the function of the differences may be converted to other color spaces. The interaction of the various components of the method will be described more fully below. It is possible to approximate the result by using any additive color space components whose value ranges are normalized in the equation otherwise derived, for example, for RGB, as further discussed below.

A pixel containing the collection of values for individual color components can be analyzed in percentage magnitudes of those color components. For example, in a 24 bit, 3 color space like RGB, the R, G or B value is divided by 255 to calculate the percentage. Similarly, where the percentage is unity, the number 255 can be used if the color accentuation equation is being calculated without normalization. In the CMY(K) space, the new value of the minimum-value color component (other than black) is calculated based on one of the following equations:
% MIN_{New}=[100%−(% MID−% MIN)%]*% MIN (a)
where:
MIN is the color component (excluding Black, K) in a pixel or area that has the minimum percentage value;
MID is the color component (excluding Black, K) in a pixel or area that has the middle percentage value,
MAX is the color component (excluding K, Black) in a pixel or area that has the maximum percentage value, and
MIN_{New} is the accentuated minimum percentage value color component (excluding Black, K); or
   % MIN_{New}=[100%−f(% MID−% MIN)]*% MIN (b)
   where f(% MID−% MIN) is a modifying or scaling function that takes the value % MID−% MIN as an argument.

The modifying or scaling function f(% MID−% MIN) result may be set to zero if the difference between MID and MIN is very small. The scaling function f may be a constant times (% MID−% MIN), as in equation (a). The modifying function f(% MID−% MIN) may also increase, decrease or change the adjustment signified by the difference as a function of any of the color components present or the specific percentage relationship of the color components.

Instead of decreasing the minimum color component MIN, the maximum color component MAX may be increased. Also, both MIN may be decreased and MAX increased. The middle color component MID may also be adjusted. All adjustments are a function of the difference MID−MIN as reflected by the following formulas:
% MAX_{new}=% MAX*fₘₐₓ(% MID−% MIN) (c)
% MID_{new}=% MID*f_{mid}(% MID−% MIN) (d)
% MIN_{new}=% MIN*fₘᵢₙ(% MID−% MIN) (e)

The function or its equivalent modifies one or more of the component color values based on the difference between the two lowest percentage color component values. This can be algebraically converted to any other color space using well-known mathematical conversions.

In order to maintain brightness close to the pre-processed image, an additional adjustment to some or all color components then takes place, dependent upon the initial amount of adjustment that occurs. All or some components of a pixel or area of pixels can be modified once the function has been calculated for such pixel or area in order to maintain the original brightness or to modify the brightness of the image. Two examples are given below for RGB and YCbCr color spaces.

In general, scaling functions of any type, including non-linear functions for example a quadratic, logarithmic or exponential function or a combination of the three, may be applied to equations (a)-(e) based on any combination of the color component values. Some circumstances may require that more or less scaling occur, for example, as discussed with respect to equation (b). This applies also to equations (c)-(e). In addition to brightness compensation, a dominant color compensation, whiteness compensation and display or printing device specific compensation or scaling functions discussed below may be used. Further scaling compensation may be applied so that the output avoids full saturation when the MAX color component value is already large (in an additive space) or the MIN component is very small (in a subtractive space.) This may include two color component accentuation or adjustment

Accentuation may be equivalently performed based on lookup tables. The new color component values are determined by matching the original color component values to those in the table and reading the new color component values out of the table for that color component set. The middle two columns of FIG. 4 would be a partial example of such a lookup table.

Utilizing lookup tables as the basis for fetching a value from an input value may increase processing performance in certain circumstances. For example, the value (% MID−% MIN) may be utilized as an offset into a lookup table or a two-dimensional index of (% MAX, % MID). Similarly, the compensations and adjustments described herein may further affect the (% MID−% MIN) or (% MAX−% MIN) value as a means of improving code execution speed. Common assembly-level computing instruction sets and higher-level languages such as C, C++, and many others have inherent indexing capabilities that make such an implementation very efficient. The need for complicated mathematical calculations being performed during run time can be eliminated or reduced.

Other rules and functions can apply such that some darker wood tones and other muddy, dull or low intensity colors would not be changed. Also, as colors get more white, additional compensation is required. The goal for color accentuation can be changed through scaling functions to, for example, maintain a particular color's dullness and make some chosen colors brighter or more intense or to literally change some colors by increasing or decreasing one primary color more than another. As was discussed with respect to equations (b)-(e).

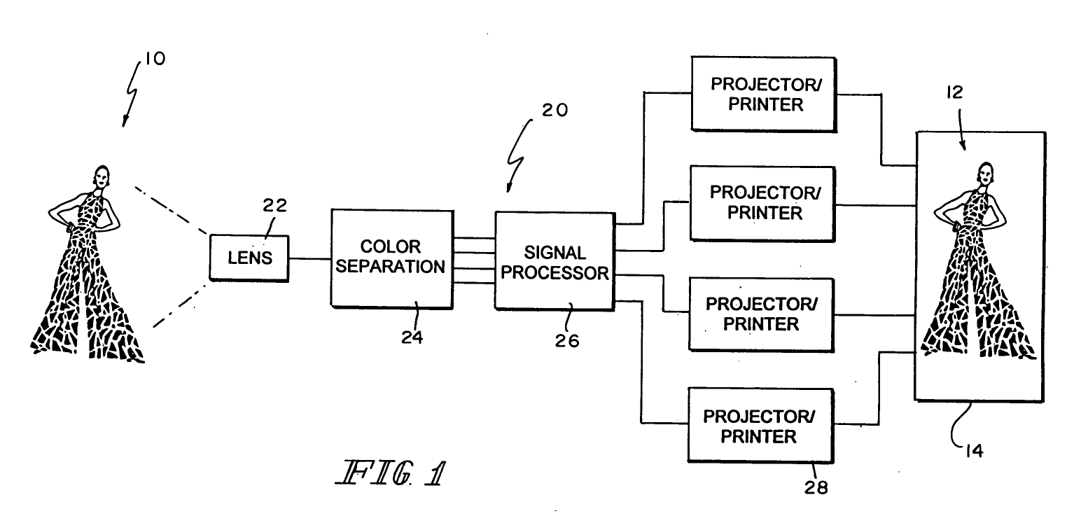

FIG. 1 illustrates a color processing system 20 for reproducing a color image 10, as image 12, on a media 14. If this is a printing process, then media 14 is the object on which the printing is performed. If it's a display like a television or CRT, then media 14 is a display. The color processing system 20 generally includes a lens 22 providing input signals of the image 12 to a color separator 24. The color separator 24 provides a minimum of three colors and in this example, four color signals to the signal processor 26. The signal processor 26 then provides appropriate drive signals to projectors or printers 28, depending upon whether it is a printer or a light projector.

Four projectors/printers are shown but other projector or printers may be used depending upon the number of colors being processed. For example, it could be a three color additive system, a four color separation system, or a six color system.

The color processing system 20 can be thought of as a combination of components to process the color signal. For example, The lens 22 would introduce a color image to a color encoding system 24 that color separates a pixel into color components for a given color space. The encoded image information is presented to a signal processor 26 that applies scaling functions that affect the color accentuation and also applies color space transformations. Upon completion of the signal processing, the image information is transferred to the projector/printer 28 to recombine color components through either a light projection, ink printing system, or other recombinant method to form the processed image 12. Practitioners of ordinary skill will recognize that the digital data comprising the original encoded image or the processed image can be stored as digital files on digital recording media and/or transmitted as digital files such that the components of the system depicted in FIG. 1 may be separated physically and not reside within a single apparatus.

The color accentuation of the present method would be in the signal processor 26. The signal processor 26 may be part of the original camera or scanner and/or may be in the signal processor 26 for the projector or printer. The signal processor 26 may be part of a device that either plays back pre-recorded video media or processes video signals received by the device. These may include, for example, television or other display devices, as well as DVD-R or other video storage devices. The signal processor 26 may include well-known signal correction software modified to incorporate the present invention.

The present method will be described with respect to a color separation system, for example, CMYK with the principles applicable to other color separations including the color formats RGB, RYB and color spaces LCH, HLS, YUV, YCbCr, YPbPr, HSV, HLS and CIE-LUV. Some of these systems deal with hue (H), saturation (S), luminance or lightness (L, Y), and chrominance (C) or the difference of a three-component color system (U, V; Cb, Cr; Pb, Pr). Saturation is the degree of color intensity. Hue is also known as the name of the color and luminance is the degree of light/dark of the color.

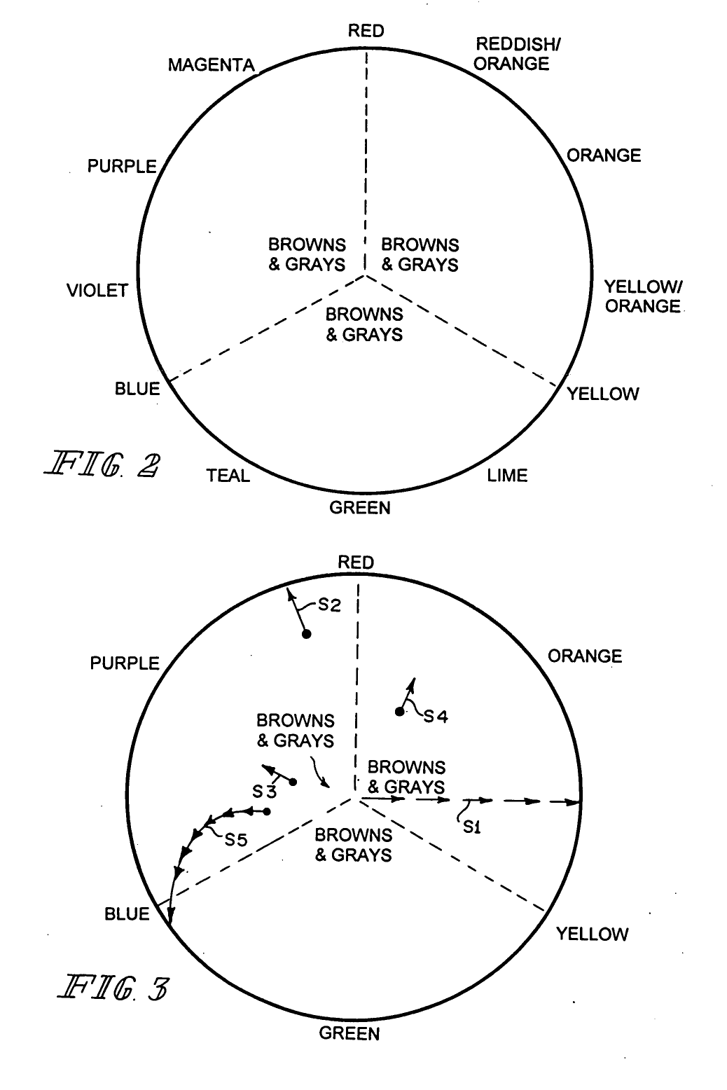

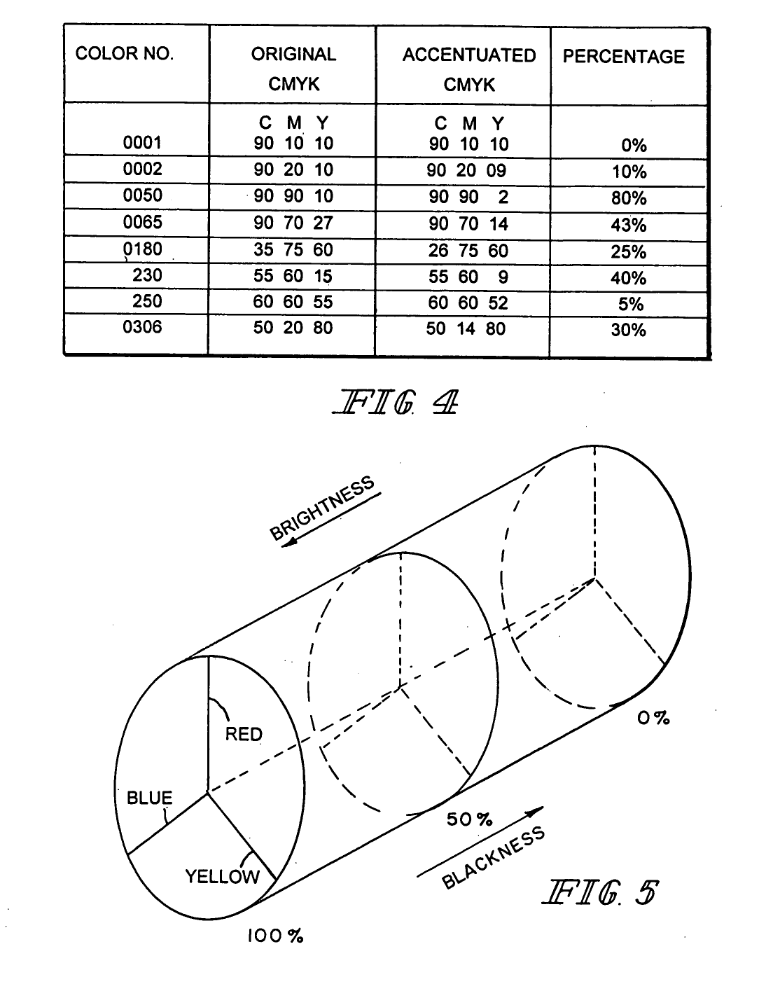

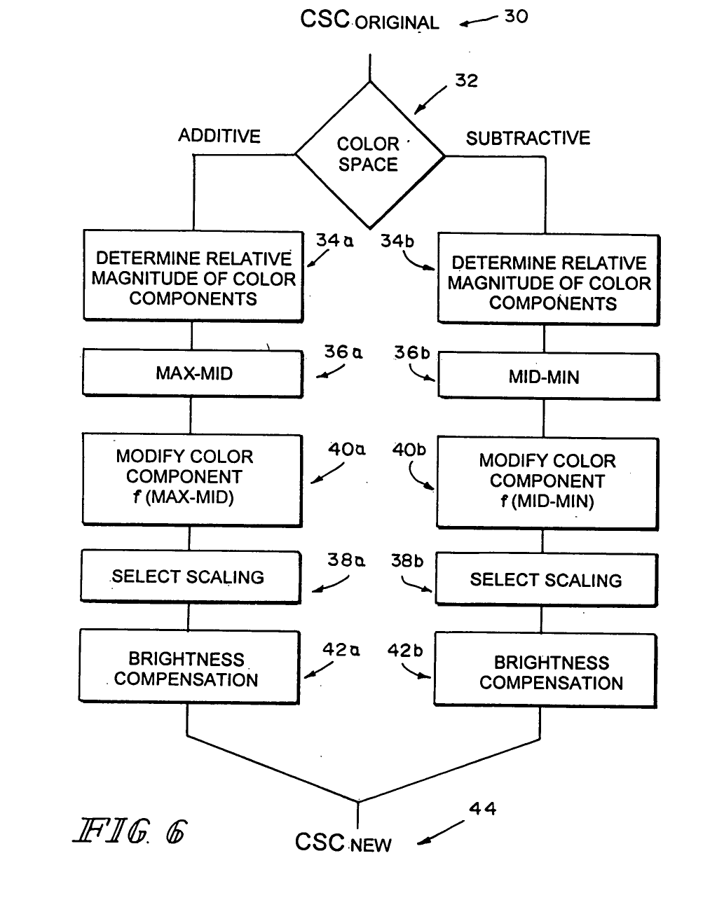

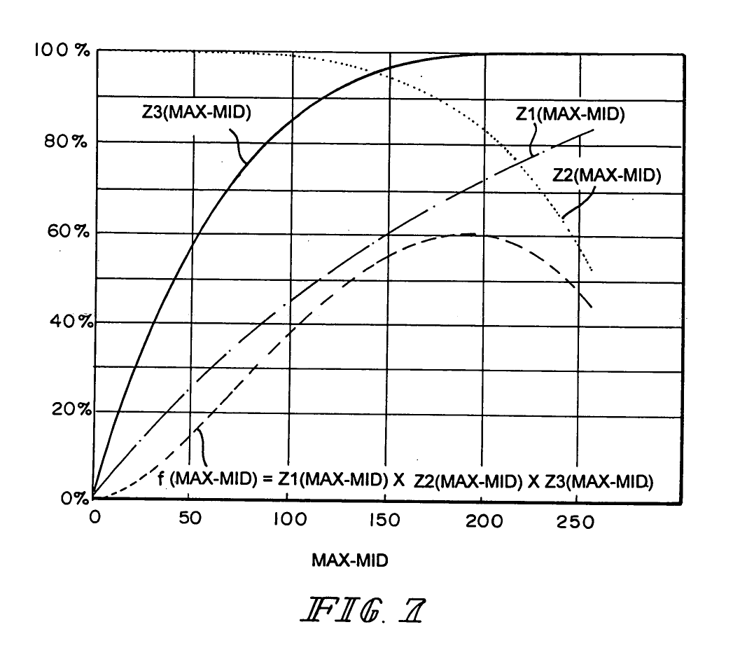

In FIG. 2, note that any color on the outside of the wheel is vivid and/or pure. Any color on the outside of the wheel is either one primary color or combinations of two primary colors, as in a rainbow. If any amount of a third primary color is added to the outside of the wheel, the color starts becoming dirty, less vivid, and moves into the interior of the wheel. As it approaches the center where all three colors have substantially the same or equal value, it becomes dirty gray or brown, depending on its component colors. Eventually, as the color component percentages become large and near equal, the color becomes dirty gray which is the center of the wheel.

The FIG. 3 wheel is the 100% slice through a solid color cylinder (“color pipe”), the surface of which contains the three primary colors Red, Yellow, Blue, equally spaced along the circumference. The slice of the color cylinder ranges in intensity from 0% at one end of the cylinder to 100% at the other end. FIG. 5 shows a conceptual view of the color pipe. FIG. 10 shows a conceptual view of the whiteness of a color pipe, as discussed below.

The percentage shown on the color pipe signifies the maximum value of any of the three primary colors. Thus, if Red is the maximum color at 80%, the color wheel would be the 80% wheel of the color pipe.

The representations of the pipe and the wheel are to illustrate the principles fundamental to this invention. To be on the outside of the color wheel, one color may be at 100% for a 100% slice of FIG. 3, a second color may be at any percentage, but the third color must be at 0%. Any multi-component color which contains more than two of the primaries Red, Yellow, Blue must be inside the “color pipe”, and not on the surface. The colors within the circle appear dirty, having tones of brown and gray. A scaling function S₁ is shown which increases between the center and the outside of the wheel. This function increasingly reduces the contribution of the minimum third color (in a subtractive space) as that third color gets closer to the outside of the wheel. The equivalent dynamic in an additive space is that the function increases the contribution of the maximum color component. A set of scaling function adjustments S₂, S₃ and S₄ are also shown. They illustrate that the scaling function varies as the color moves from dirty, for example, toward pure. S₂ shows adjustment for an original color close to a pure color. S₃ and S₄ show additional smaller adjustments.

The arrows show the adjustment of the value of the color components using a scaling function that modifies the total color component values so that the total color moves towards the outside vivid portion of the circle. The scaling function is based on differences between color component values. The length of the arrow represents the relative adjustment for one example scaling function. The amount of accentuation relates directly to the arrow length for that pixel accentuation. The closer a color is to the outside of the wheel, the more it is accentuated towards a vivid pure color on the outside of the wheel. However, as explained below, in a practical system, the color can saturate the range, so the scaling function may become attenuated for color values close to the maximum in the range, thus causing the accentuation to occur primarily in an annular ring of the color wheel.

S₁, S₂, S₃ and S₄ are shown as radii since the adjustment is of only one color component. If changes are made to more than one color component, the result may not be a radii as shown by S₅, depending on the function. This example scaling function S₅ shows a curved adjustment favoring one of the primary colors. The scaling function can change in any dimension in the color pipe. A scaling function may also be used which moves circumferentially and changes the color or hue. This would result by changing two of the three colors. The color pipe and wheel also have a fourth dimension of white/black (not shown). The fourth dimension adds amounts of white or black to lighten or darken/dull any color on the pipe/wheel by degrees of colorless gray (black into white). FIG. 10 shows the degree of white of a color pipe/wheel. It begins from black at zero and proceeds to white at 100%. These are the same percentages slices as described with respect to FIG. 5. As discussed previously, the center of the slice represents all three colors having the same value. It should also be noted that the size of the slices is illustrated in FIG. 10, which illustrates the amount of differences that may occur from one of the colors being zero and at least one of the other colors being a maximum on the surface of the circumference of the slice. A compensation scheme based on the amount of whiteness will be discussed below, with respect to FIG. 10. The pipe/wheel dimensions are red, yellow, blue, and black.

In the example illustrated in FIG. 4 for the CMYK color system, the original value is shown in one column as a percentage of saturation for each of the component colors. Black or K has not been shown for sake of clarity since it is not used to determine the adjustment nor is it adjusted. During the next phase in FIG. 4, for example, the accentuated/adjusted numbers are shown in the third column and the last column shows the percentage of accentuation. In this example, the difference between the middle and lowest color magnitude is taken and this difference is the accentuation percentage factor.

For example, with a simple % scaling function for color 0001 having C=90, M=10, Y=10, the difference between M and Y is zero and therefore there is zero percent adjustment to the lowest color. Alternatively, since both M and Y dirty C, both M and Y may be reduced the same amount.

For the color 0002 having C=90, M=20, Y=10, the difference between M and Y is 10 so the third color Y is reduced by 10% from 10 to nine. For the color 0306, C=50, M=20, Y=80 become C=50, M=14, Y=80. The difference between C and M is 30 and therefore there is a 30% reduction in the lowest percentage color M. For the color 0065, the percentages are C=90, M=70, Y=27. The difference between M, the middle color, and Y, the lowest color, is 43, so Y now becomes 14. Thus, the “dirtiness” of this color has reduced by approximately half using this function. This system method can be converted to any other color system by known conversions.

In the present system, no specific color is adjusted, but the lowest of three colors is the one that is adjusted downward in magnitude. This system works in such a way that grays, browns and pastels do not change or change little. When the color is gray-brown, for example, 70% for cyan, magenta and yellow, there is no accentuation because there are not substantial differences between the minimum color percentages.

Although the example is shown as reducing the percentage of the lowest color, the other color components may also be adjusted. For example, the highest may be increased by itself or in combination with lowering the lowest. Also, the middle color can be raised. All of these reduce the effect or contribution of the third or lowest color.

As previously mentioned, there are certain combinations which could or could not be changed. For example, for color C=250, Y=60 and M=55, the Y and M components differ by only five percent. This color would not become substantially more intense or vivid by lowering 55 by the five percent using these methods. Thus, this color could remain in its present state by setting the scaling function result to zero.

Also, depending upon the order of the percentage of the color or other color component information, the scaling function may be a modification of the numerical difference of the middle and lowest percentage of color components, as discussed with respect to equations (b)-(e) for a subtractive color space. The primary colors have different degrees of dirtiness. Blue contributes more dirtiness than red which contributes more than yellow for example. Thus if blue is the lowest percentage color component it will be reduced more than if red or yellow was the lowest percentage color component. Also, different colors saturate quicker than others and differently in different color spaces. For example, in typical media devices, red often saturates quicker or more than green or blue and, thus, would use a different scaling function. Saturation is discussed in detail below. Also, if the to be adjusted color component is large, a scaling compensation may be required as discussed in detail below.

It is well understood in the art that equations describing calculations in a given color space may be transformed algebraically into different but functionally equivalent calculations in a different color space using well-known mathematical transformations such that the results are substantially equivalent. For example, the practitioner in the art will recognize that the equation (b) which is defined for use in a subtractive color space (e.g. CMYK), can be transformed for use in an additive color space (including RGB) as follows, for example:
% MAX_{New}=% MAX+f(% MAX−% MID)*(100%−% MAX). (f)

An example of a non-linear function of f(% MAX−% MID) for RGB (or other additive color spaces) is as follows:
% MAX_{New}=% MAX+a*(1−e^{(-b*(% MAX-% MID))})*% MAX*(100%−% MAX) (g)
where a and b are numerical constants. The nonlinear of equation (g) can be transformed into any other color space. In addition, the practitioner of ordinary skill in the art will recognize that the scaling function for RGB can be itself transformed into other color spaces using well-known transformations, including to YCbCr, YUV.

The most general form of the invention for additive color spaces would be:
% MAXnew=% MAX*f(% MAX−% MID). (h)
Similarly, programmers may alternatively use the form:
% MAXnew=% MAX+f(% MAX−% MID), (i)
where the function f(% MAX−% MID) expresses the magnitude of the color accentuation. Practitioners of ordinary skill will recognize that as a result of the different forms of scaling function possible, it may be advantageous to express the color accentuation function in a manner that is implemented in a lookup table. In the preferred embodiment of this technique, the equation (i) is modified so that its form is:
% MAXnew=% MAX+f(% MAX, % MID). (j)
As explained below, this implementation makes it possible to experiment with a variety of scaling functions, f, without reprogramming extensively. In addition, the compensations to the scaling function can be easily implemented by simple offsets to the input indexes of the table expressing the scaling function f.

The practitioner of ordinary skill in the art will recognize that equation (f) is an example of equation (h). The form of equation (h) may provide computational efficiencies and is easier to manipulate in conversions between color spaces. For clarification, the practitioner of ordinary skill in the art will recognize that “% MAX” is the number equal to the value of the MAX color component divided by its range. Thus, as an example, in RGB space, if the MAX component value is 128, then % MAX=128/255=0.50.

A more general form of non-linear scaling function of f(% MAX−% MID) for RGB (or other additive color spaces) can be used that avoids over-saturating color by having a shape that rolls-off when the MAX−MID approaches its maximum. One example of a scaling function that has six parameters to adjust the overall shape of the function to meet the requirements of particular display or output devices is:
f(% MAX−% MID)=Z1*Z2*Z3, (k)
where:
Z1=a*(1−e^{(-b(MAX-MID)/255)})
Z2=−((MAX−MID)/(255*c))^{d}+1
Z3=−(((MAX−MID)/(255*g))−1)^{h}+1

This scaling function has six parameters, a, b, c, d, g, and h that can be adjusted to change the shape of the scaling function. In cases where the color data coding uses more than 8 bits per color component, the 255 divisor in these equations will be changed to be equal to 2^{(# bits per component)}. The parameters are typically set so that there is an initial concave upward or monotonically increasing section near where MAX−MID is close to zero that then enters a concave downward or plateau peak area where the color accentuation effect is at its maximum, which then rolls off back down or monotonically decreases toward the minimum effect to be applied where the maximum input for MAX−MID is reached.

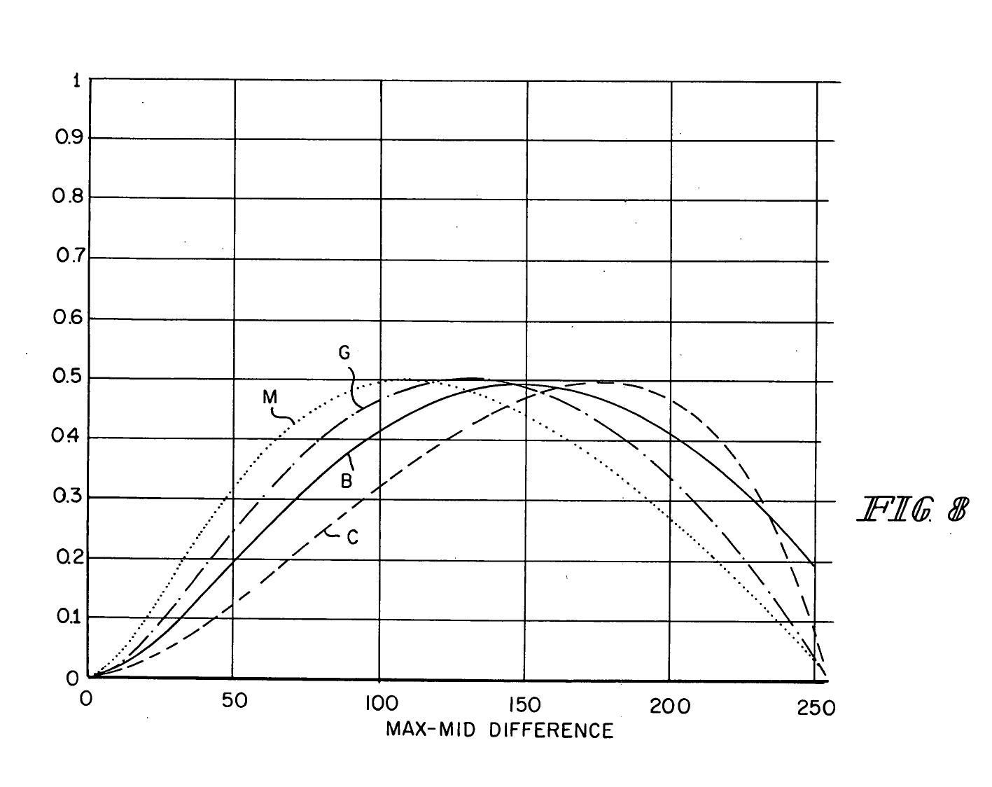

An example where a=0.6, b=1.0, c=1.2, d=4.0, g=1.0 and h=4.0 is shown in FIG. 7. The percentage of scaling from zero to 100% is graphed as a function of the difference from 0 to 255 for the three functions Z1, Z2 and Z3 and the product f(% MAX−% MID). The initial rise or increase from zero can be between 20% to 100% of the range of differences. The peak, which may be a plateau, may be between 0% to 80% of the range of differences. The final decline or decrease may be 0% to 60% of the range of differences.

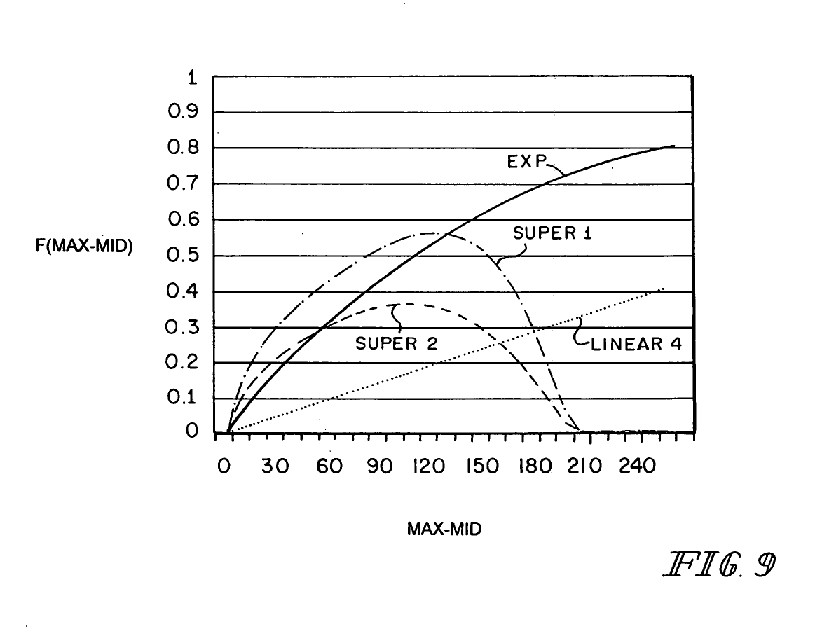

FIG. 8 shows examples of four other scaling functions using equation (i). The constants are as follows:

| Curve | a | b | c | d | g | h |
|---|---|---|---|---|---|---|
| B | 1 | 1.2 | 1 | 6 | 1 | 4 |
| M | 0.7 | 8.5 | 1 | 2 | 1 | 4 |
| G | 0.67 | 4.5 | 1 | 3 | 1 | 4.5 |
| C | 1.35 | 5 | 1.1 | 1.5 | 1.5 | 2 |

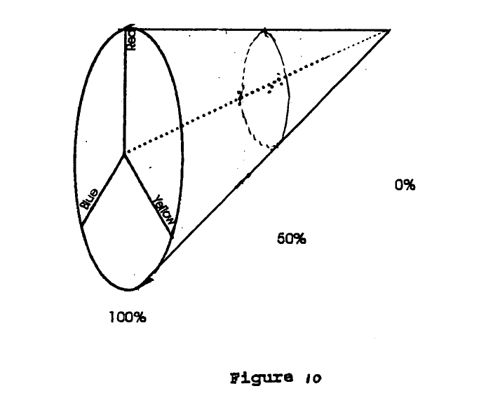

FIG. 9 shows two other examples (super1 and super2) of the scaling function compared to an exponential (exp) and linear (liner.4) version. The constants for exp, super1 and super2 for equation (i) are:

| Curve | a | b | c | d | g | h |
|---|---|---|---|---|---|---|
| exp | 1 | 1.6 | 0 | 0 | 0 | 0 |
| super1 | 0.8 | 3 | 0.8 | 5 | 0.5 | 5 |
| super2 | 0.8 | 2 | 0.8 | 2.5 | 0.5 | 5 |

The linear f(MAX−MID) is 0.4 times (MAX−MID). A review of the curve for super1 shows a peak or relative plateau above 0.5 in the range of 80 to 150 or approximately 27% of the total difference range. Super2 peaks or plateaus above 0.3 in the range of 55 to 145 or 35% of the total difference range. Also, whereas super1 rises over 40% of the difference range and decreases over 22% of the difference range, super2's rises and falls are more equal over 22% of the difference range. Both are at zero over 30% of the difference range.

This general scaling function shape can be adjusted to optimize the color accentuation effect to meet the requirements of particular storage, transmission, display or output devices. The practitioner of ordinary skill will recognize that a variety of algebraic functions can be devised that produce an equivalent shape that provides maximum color accentuation in a region between the lowest values and highest values for MAX−MID (in an additive color space). The equation (h) can be transformed into any other color space. Alternatively, it can be used in some additive color spaces, for example, Y Cb Cr or Y U V, as an approximation, as described below.

In this example, the algebraic transformation of the equation from a subtractive space to an additive space converts the comparison of the two minimum color component magnitudes to examining the magnitudes of the two maximum color components and scaling the color component values based on the difference between the maximum and middle values of the three color components. In other words, the practitioner of ordinary skill will recognize that lowering the magnitude of the minimum color in CMYK is the equivalent of raising the magnitude of the maximum color in RGB space.

It is also possible in some cases to use equation (h) and other equations derived for the RGB color space in other additive color spaces without transforming the algebra into that color space. This is most easily accomplished if the scaling function is adjusted to accommodate this approximation. Thus, in a YCbCr space, the color components are normalized so that they have the same range of values, and then the MAX−MID is calculated and adjustment made to the appropriate Y, Cb or Cr component. The result is then de-normalized to produce the output Y Cb Cr pixel value in the numerical range required for the Y Cb Cr signal definition. This is especially effective if each of the Y, Cb and Cr components have a unique corresponding scaling function. It is also equivalent to incorporating the normalization and de-normalization directly into the scaling function corresponding to the maximum color component.

When one reviews the following well-known conversion equations from RGB to Y Cb Cr, one can see that this approximation is accurate.
Y=0.257*R+0.504*G+0.098*B+16
Cr=0.439*R−0.368*G−0.071*B+128
Cb=−1.148*R−0.291*G+0.439*B+128
For example, if Y is increased, green is increased relative to the other two colors. When Cb is increased, blue is increased relative to the other two colors. When Cr is increased, red is increased relative to the other two colors. Also, when one takes the difference of Y Cb Cr, again, only one color is more dominant and moves further from another color. For example, in Y minus Cb, green is increased while blue is decreased. When one takes the difference of Y minus Cb, one will see that it includes green minus blue. When one takes the difference of Y minus Cr, it includes the difference of green minus red. When one takes the difference of Cb minus Cr, it includes the difference of blue minus red. These are mere approximations because their coefficient values are associated with each of the color components and, therefore, it is not a one-to-one correspondence. However, it does show that there is a correlation and a rough estimation to provide a first order approximation. This approximation is improved by multiplying one equation by a constant before the subtraction. This is but one example of where the concept of the present invention works using the difference between the MAX and MID for an additive color space not using RGB.

Another method of approximation in the YCrCb space using known scaling functions from the RGB space is as follows. The following difference equations are calculated:
R−G=2.409*(Cr−128)+0.391*(Cb−128)
R−B=1.596*(Cr−128)−2.018*(Cb−128)
G−B=−0.813*(Cr−128)−2.409*(Cb−128)
A logic table determines whether R, G or B is the MAX or MID, and MAX−MID is already calculated. This difference is used in a look-up table to determine the scaling function F of RGB for the corresponding MAX. For the present example, green G is assumed to be the MAX and, consequently, green G is to be accentuated. The following equations are an approximation of the adjustment:
Ynew=Y+0.504*F*AVG(G)
Crnew=Cr−0.368*F*AVG(G)
Cbnew=Cb−0.291*F*AVG(G)
where AVG is an average value for R, G, or B and generally selected to be in the middle portion of the difference range as discussed with respect to FIGS. 8 and 9. Although the same AVG may be used for each of the three Y, Cr, Cb equations, a different AVG may be used for each of Y, Cr, Cb. Where R is MAX, the adjustment of the three color components to Ynew, Crnew, Cbnew would use the coefficients of R (0.257, 0.439, −1.148) from the above YCrCb equations and, if B is MAX, the coefficients (0.098, .−071, 0.439) are used. Thus, an approximation of the accentuation is performed without a complete conversion to RGB nor an exact conversion of the scaling equations which would require substantial computation. Another advantage is that the MAX−MID is calculated once for two pixels because Y falls out of the equation. The practitioner of ordinary skill will recognize that many video systems share a single Cb and Cr value pair between two different pixels, where the Y value is the only color component difference between the two pixels.

The above coefficients relating to YCrCb and RGB are but an example of one set used for one standard. There are other known and possibly to be developed standards with different coefficients that can be used with the present method.

This approach is equivalent to using three normalized axes on the color wheel other than R Y or B, but which each represent pure hues comprised of two primary colors. The adjustment moving vectors S₁, S₂, S₃ or S₄ in FIG. 3 toward the outer rim of the wheel can be accomplished by adjusting the component value along one of such axes, even if it is not a pure primary color axis. For pixels where the MAX color component is the substantially predominant in the pixel, the movement of the pixel color value on the color wheel is substantially radial, and thus this approximation is accurate. For pixels where the color is a hue where the MAX color component is closer to the MID, then there may be hue changes when the color accentuation takes place. In these cases, the scaling function can be designed to compensate.

One compensating scaling function takes the MAX−MID argument, but also adjusts the value of the MID component so that the pixel color position on the color wheel moves radially outward. Adjustment of the MAX produces an equivalent effect.

Conditions exist where the perceived color is not actually the color measured as the maximum color component in the pixel (for an additive color space, referred to below as MAX) and as the minimum color component in the pixel (for an subtractive color space, referred to below as MIN). In addition, it may be desirable to maintain a color balance that requires adjustment of the MID color component value in relation to the MAX (or MIN) value as well as adjustment of the MAX (or MIN) value. Given some change in MAX (or MIN) due to the color accentuation technique, a related and proportionally change in the MID value might be desirable. The effect should work so that when MID is close to MAX (or MIN), MID should be adjusted more than if MID is further away from MAX (or MIN).

Any changes in MID value should be continuous and contiguous at boundary conditions. Thresholds can still be used, but from the point where the threshold condition is met, a piecewise continuous adjustment would be desirable. A threshold THRESH_{MID} is defined as the magnitude of MID above which adjustment occurs relative to the amount of color accentuation in MAX (or MIN). This threshold can be defined as a parameter under manual control, such as an absolute distance from MAX (or MIN), or be fixed. Alternately, and the preferred embodiment, is an automatically calculated distance based on MAX and MIN values.

The THRESH_{MID}, is defined to be between MIN and MAX for an additive space as:
THRESH_{MID}=MIN+(MAX−MIN)/A
where A is some constant that weights the distance closer to either MIN or MAX. When A=2, the THRESH_{MID} is located half way between MIN and MAX. MIN can take on any value greater than or equal to 1.0. The desired effect in this embodiment is as follows:
Case 1: When MID is less than THRESH_{MID}, no change occurs to MID.
Case 2: When MID is greater than THRESH_{MID}, MID is boosted relative to MAX.

An example of a calculation that implements the embodiment for Case 2 (for an additive space) is:

$${MID}_{NEW} = [ 1 + ( \frac{{MAX}_{NEW} - {MAX}_{ORG}}{{MAX}_{ORG}} ) \times ( \frac{{MID}_{ORG} + {THRESH}_{MID} - {MAX}_{ORG}}{{THRESH}_{MID}} ) ] \times {MID}_{ORG} \qquad ( 1 )$$

The term:

$$( \frac{{MAX}_{NEW} - {MAX}_{ORG}}{{MAX}_{ORG}} )$$

represents the relative change in the magnitude of the MAX color component after color accentuation occurs.
The term:

$$( \frac{{MID}_{ORG} + {THRESH}_{MID} - {MAX}_{ORG}}{{THRESH}_{MID}} )$$

scales the adjustment to the MID value. Less adjustment occurs as MID gets closer to THRESH_{MID}. More occurs as MID is closer to MAX. The dynamic in MID is subject to two inputs: first, the amount of change in MAX and second, the relative position of MID to the THRESH_{MID}. An alternate calculation of THRESH_{MID} could be MIN+(MID−MIN)/A. Practitioners of ordinary skill will recognize that instead of an absolute threshold described above, a continuous adjustment can be calculated where the magnitude of adjustment of MID decreases as MID approaches toward MIN can be used instead. An illustrative example of this kind of calculation to replace thresholding is explained below with regard to the scale-back function. Although THRESH_{MID} is set and used in equation (m) the calculation may be performed even for Case 1.

The practitioner of ordinary skill in the art will recognize that there are a wide variety of functions that monotonically increase MID as the amount of color accentuation applied to MAX increases. In addition, scaling compensation brightness compensation and whiteness compensation may be applied to the MID component in a similar manner to that explained for the MAX color component.

As previously discussed, brightness compensation acts to offset the overall brightness change in an image after the initial color accentuation takes place. In RGB or other additive color spaces, color accentuation acts to brighten a pixel by adjusting one color component upward in value based on the color accentuation function. The accumulation of accentuation across an image therefore increases the “brightness” of the image. The brightness compensation may affect all three components in a pixel proportionally to the amount of accentuation on the accentuated component in the pixel.

The operation describing Brightness Compensation for all three components is as follows:
% MAXnew2=% MAXnew*BrightnessScale*(% MAXnew−% MAX)+% MAXnew (m)
% MIDnew=% MID*BrightnessScale*(% MAXnew−% MAX)+% MID (n)
% MINnew=% MIN*BrightnessScale*(% MAXnew−% MAX)+% MIN (o)
wherein the input components to brightness compensation, after color accentuation are % MAXnew, % MID, and % MIN and the output after brightness compensation are MAXnew2, MIDnew and MINnew. A user controlled or set scaling multiplier BrightnessScale is a parameter used to further scale the magnitude of the brightness compensation operation.

It should be noted that brightness compensation may also be performed in RYB, CMY and CMYK color spaces as well as using the brightness, luminance or lightness L of other polar color spaces for scaling. The operation of this process may be transformed through standard color space conversions and are equivalent.

Brightness compensation may also be performed to preserve the characteristic brightness as described by the “Y” value in color spaces YUV, YCbCr, etc. The process is as follows:
Perform the color accentuation step on the image in RGB or any other color space, after conversion from YUV or YCbCr, as the case may be, to RGB (or that other color space).
Calculate the original and new Y values Y and Ynew through the color space conversion equations that define the conversions from RGB to YUV, or RGB to YCbCr (if the other color space is RGB, for example).
Using the arithmetical relation of Y and Ynew (for example, their ratio), scale the magnitudes of the two color components of the pixel that have not been adjusted by color accentuation (e.g., MIDnew and MINnew in RGB color space). The resulting three components are the pixel output in RGBnew (or whatever the other color space is).
Transform the new RGBnew result (or whatever the other color space is) to YUVnew or YCbCrnew using well-known transform arithmetic, resulting in a YUV or YCbCr brightness compensation.

Alternatively, the brightness compensation in Y may scale all three color components or just one color component. The number of color components scaled may be a function of the transformation equations for Y. Also, the brightness correction should not substantially diminish the results of the color accentuation.

If the color accentuation is applied in Y Cb Cr space directly, then the brightness adjustments can take place in the scaling function and conversion into and out of RGB space described above are skipped.

When a particular color component of a pixel is especially prominent in an image, color accentuating the image can make the image appear “over saturated” in that dominant color. The result may be unsatisfactory. Dominant color compensation may be used to control the amount of color accentuation that is applied to a dominant color to minimize over saturation of the dominant color in the frame or image.

Dominant color compensation begins with measuring the image as a whole for the relative prominence of a particular color component. In RGB space, an additive color space, this test is for Red, Green, and Blue. In CMY or CMYK color spaces, subtractive color spaces, the test is for Cyan, Magenta, or Yellow, where black is ignored in the CMYK color space. One preferred embodiment is to average the separate color component values across the entire image. A result for each color is obtained. For the RGB color space, an average value for each of Red, Green, and Blue are obtained. The highest value is considered the prominent color.

The difference between the highest average color value and the next-highest average color value is used to scale the amount of color accentuation applied to any pixel. This difference between the highest and next-highest average color values are inputs to a mathematical function, which then creates a color prominence multiplier. This is implemented by multiplying the result of the average-value difference function by the resulting scaling function for that pixel. It is applied only to those pixels where the maximum color component for the pixel is the same color component as the maximum average color component of the image.

The following equation describes this process for RGB or other additive color space:
% MAXnew=% MAX+f(% MAX−% MID)*g(AVGmax−AVGmid)*(100%−% MAX)*% MAX (p)
where
AVGmax is the averaged color component value across all pixels in an image that has the largest resulting value;
AVGmid is the averaged color component value across all pixels in an image that has the next-largest resulting value;
g(AVGmax−AVGmid) is a function that calculates the amount of color prominence scaling that should be applied to an image when the MAXold color and AVGmax color are the same color component.

For subtractive color spaces, the inverse would apply. The dominate color component would be the minimum color component and the compensation or prominence scaling would be g(AVGmid−AVGmin) in equation (b) for % MIN.

This adjustment for color dominance in a region can also be achieved using convolution. For a given pixel with a maximum color component, a convolution is performed that integrates over all the neighboring pixels within some radius R, the cumulative sum of each magnitude of the same color component divided by their corresponding distances from the given pixel. The scaling function applied to the given pixel is multiplied by a coefficient inversely proportional to the convolution result. In this manner, when a pixel resides within a region where the same maximum color component is heavily dominant, the scaling function is reduced in effect. The practitioner of ordinary skill in the art will recognize that similar convolution results can be achieved by using the distance to some power, or the color component magnitude to some power or some combination thereof. An example equation is presented:

The convolution result for a pixel located at point x,y in the image is calculated as:

$$Cx , y = {\sum }_{{x}^{′} = x - {x}_{0}}^{{x}^{′} = x + {x}_{0}} {\sum }_{{y}^{′} = y - {y}_{0}}^{{y}^{′} = y + {y}_{0}} \frac{\% MAX ( {x}^{′} , {y}^{′} )}{{( {x}^{′} - x )}^{N} + {( {y}^{′} - y )}^{N}}$$

where % MAX(x′,y′) is the value of the color component being analyzed at point (x′,y′) in the image. X₀,Y₀ are the dimensions of the region of convolution, and N is the selected sharpness of the convolution function. When the MAX color is dominant in the region of convolution, Cx,y is large. Thus, the scaling function can be attenuated by a number inversely proportional to Cx,y or Cx,y raised to some degree. The practitioner of ordinary skill in the art will recognize that this technique is equivalent to convolving across any shape surrounding the point X,Y. For most images, the computationally easiest form is the rectangular shape, with the convolution calculated discretely, as demonstrated above.

Practitioners in the art will recognize that there are a variety of convolution calculations similar to that explained above, that effectively combine the color component values around a pixel can be used to achieve a result where a localized value consistent with the region is used as the value of MAX in the color accentuation equations. For example, a simple average can be used, where the denominator of each term in the summation equation is simply the number of pixels bounded by x0 and y0. In another example, one can calculate a weighted average where the denominator of the summation is the sum of all the weights, and prior to each addition of the terms, each % MAX value is multiplied by a pre-determined weight corresponding to a location within the mask whose size is determined by x0 and y0. In these cases, in place of the actual measured % MAX of the pixel subjected to accentuation, the result of the convolution calculation is used.

As previously discussed, the scaling functions can be applied such that a different scaling function is applied depending on which color component is the MAX (in the case of an additive color space) or MIN (in the case of a subtractive color space). In other words, each color can have a different scaling function for the same differences. This is another way of dealing with the over saturation problem in at least some colors. For example, often R is accentuated too much, while the G and B are acceptable when all three use the same scaling function. The practitioner of ordinary skill will recognize that each color component can have its own scaling function such that when a given pixel has a color component selected as MAX (in the additive case), then the scaling function for that color is used for that pixel. In the typical case, the R scaling function is less than the scaling function for G and B. The practitioner of ordinary skill will recognize that the selection and shape of the scaling functions for the different color components will depend on the characteristics or requirements of the particular display or image output device, storage device or where the color coding and decoding signal process is situated.

In certain cases, a particular display or printing device may have particular visual characteristics, in other words, its color response function may have non-linear aspects. Therefore, the scaling function can be modified to complement these effects. For example, where the display device would appear to over saturate at certain levels when color accentuation is applied, the scaling function can be modified to level off when % MID-% MIN reaches a certain threshold and roll-off when it reaches a second threshold. Similarly, when % MID−% MIN is less than a certain threshold, the scaling function can be set to a set amount. Practitioners of ordinary skill in the art can construct smooth transitions from the scaling function domain across the threshold to the domains where the scaling function value is set to a different function.

Whiteness compensation addresses artifacts that become visible after Color Accentuation is applied under certain conditions in where the color components of a region are “near white”. The term “near white” will apply to the colors which are at or near the white end of the pipe/wheel of FIG. 10, and also to those colors close to the center of the pipe where all three color components are somewhat close in value. For example, in the additive RGB color space (by way of explanation, the same effect occurs in the subtractive space, but the algebra is transformed), Color Accentuation may cause a pixel, or group of pixels, to stand out against it's surroundings because of local variations in the value of (MAX−MID). This results in some neighboring pixels being accentuated more than others. Thus, the apparent brightness or contrast between neighboring groups of pixels after accentuation may be more than before, and sufficiently so to be more perceptible. This effect is typical in images that have color noise or compression artifacts. This effect is more noticeable when the color component values are higher in value, i.e. closer to white values (closer to pixel values of 255 in 24-bit, 8-bit per pixel, RGB conditions). At the black end of the color pipe of FIG. 10, the effect is not as perceptible. At the white end of the pipe, the differences can be larger and thus the differences between neighboring accentuated pixels or regions is more perceptible.

The whiteness compensation adjustment scales back the amount of color accentuation under certain conditions. The reduction is made relative to the MIN component value in the pixels for an additive color space and the MAX component value for a subtractive color space. The following will discuss the additive color space as an example and is applicable the subtractive color spaces as discussed for other compensations and adjustments. When the MIN component value of a pixel is larger, then the entire pixel is closer to the white end of the color pipe. Thus, more scaling back of the accentuation should occur when the MIN value gets larger, regardless of the MAX−MID value in an RGB color space.

In one embodiment for an additive color space, this method uses a near white compensation or offset “OFFSET_{nwo}” to the indexing of (MAX−MID) in the f(MAX−MID) color accentuation algorithm. When a lookup table is used, it literally is an offset of the index into the (MAX−MID) portion of the table. A maximum offset value is scaled by the value of MIN. Higher MIN means more offset of the (MAX−MID) value. Algebraically, this embodiment is as follows: Assume that for each color plane, R, G and B, there is a constant controlling the magnitude of the whiteness compensation effect. They are named:
OFFSET_{NWC}_{_{—}}red
OFFSET_{NWC} green
OFFSET_{NWC} blue
or generally OFFSET_{NWC} <color>.
   First an offset is calculated based on which color plane the Max color is. Then the value of MAX−MID is adjusted so that the amount of color accentuation, which is a result of a scaling function, as explained above in equation (i), becomes a function of MAX, MID and MIN as follows:
   f_{nwc}(MAX)_=(MIN/255)*OFFSET_{NWC}<color>; and % MAXnew=% MAX*f(% MAX−f_{nwc}−% MID), (q)
where <color> is the identity of the color of MAX.
   Using the general form of equation in (k) the preferred embodiment may be:
   % MAXnew=% MAX+f(% MAX−f_{nwc}, % MID). (r)
   Where f( . . . ) is the Color Accentuation Scaling Function. Where the scaling function is implemented in a lookup table such that the input index is (MAX−MID), as described above, the index is adjusted by subtracting the f_{nwc}−<color> value from MAX−MID. Alternatively, where the lookup table is a three dimensional array with MAX and MID two of the dimensions, f_{nwc} can be subtracted from MAX . . . . In all cases, the value of_whiteness compensation offset is limited to be less than or equal to (MAX−MID) so that the index does not become less than zero.

As an alternative implementation of the whiteness compensation offset can be approached by calculating the offset as a function of the difference of the MIN and either the MAX or MID as follows:
f_{nwc}(MAX)=((MIN*a)/MAX)*OFFSET_{NWC}
f_{nwc}(MAX)=((MIN*b)/MID)*OFFSET_{NWC}
Where ‘a’ and ‘b’ are constants.
Alternatively, the same scaling can be applied to all pixel values in a universal fashion.

A second embodiment of the whiteness compensation, a linear or non-linear scaling is applied to the amount of accentuation.

Given the constants:

noc<color>_ (Range of 0.0 to 1.0)
   The whiteness compensation of f(MAX−MID) is calculated as:
   g(MIN)*f(MAX−MID)
   Thus, Color Accentuation is calculated (assuming the equation form of (i)) as:
   MAX_new=MAX_old*g(MIN)*f(MAX−MID)
   An example of g(MIN) is:
   g(MIN)=nwc+(1−nwc)*((255−MIN)/255)
   An alternative is:
   g(MIN)=1−(MIN/(255*m))\hat{ }n
   where n and m are constants that shape the g(MIN) function.
   Alternatively, the same scaling can be applied to all pixel values in a universal fashion.

Max scaling compensation (or in a subtractive space, MIN scaling compensation, referred to here as “scale-back”) addresses an effect observed with images or video where the color component values are large. In an additive space, for example, RGB, the amount of color accentuation applied to the MAX color component is equal to the function f(MAX−MID) times the value of MAX, as described above in equation. Regardless of the actual value of MAX, the calculated amount of accentuation is the same. However, since the core function uses the return accentuation value multiplied by the MAX value, a larger MAX means that the change in the maximum color component value increases in absolute value when MAX gets larger. For example, if f(MAX−MID)=0.2, then when MAX_{org}=100, the new MAX_{new}=120. However, if MAX_{org}=200, then MAX_{new}=240. Although the percentage impact is the same, the absolute impact is much larger as MAX increases. Even though the scaling function may decrease as the value of (MAX−MID) increases, it is not always the case that as MAX itself increases, MAX−MID increases. The result is that color accentuation may begin saturating the maximum color too quickly.

In order to avoid this saturation, a compensation function called scale-back or scale-back compensation is used. Max-scaling decreases the amount of color accentuation monotonically as the value of MAX increases in an additive color space. In a subtractive color space, this would be an adjustment that reduces the amount of color accentuation as the value of MIN decreases toward zero. A variety of functions for scale-back can be used. In the preferred embodiment, a simple linear calculation has proven very effective. Also, different colors may require unique scale-back function characteristics. Thus, the scale-back functions may be different for each color.

In an additive space, let f_{msc}(MAX) be the function be the scale-back function based on the value of MAX which is defined to be between 0 and 255. Then we can define the scale-back function to be:
f_{msc}(MAX_{org})=p+(1−p)(255−MAX)/255
Where,
0<=p<=1.0
The parameter p defines the sharpness of the scale-back effect: that is, how quickly the amount of color accentuation is reduced as the value of MAX approaches 255, and how much of a reduction occurs. When MAX is at 255, the maximum in its range, f_{msc}(255)=p. When MAX approaches 0, f_{msc}(0)=1. The f_{msc} result is multiplied by the scaling function in the color accentuation equation, such that the resulting accentuation function in this embodiment (assuming the form of equation (i)) is:
MAX_{new}=MAX_{org}*f(MAX−MID)*f_{msc}(MAX_{org}).
The form of equation (j) would be:
MAX_{new}=MAX_{org}+f(MAX−MID)*f_{msc}(MAX_{org}).

Practitioners of ordinary skill will recognize that there are a wide range of possible scale-back functions that monotonically approach some value less than one when MAX approaches 255 and at some point when MAX is less than 255, approach the value of one. The point is to reduce the scaling function result as MAX approaches 255 (for an additive space, and for a subtractive space, as MIN approaches zero).

One example using the various compensations with one of the accentuation formula is as follows:
1. Calculate the Whiteness Compensation:
   f_{nwc}(MAX)=(MIN/255)*OFFSET_{NWC}
   Where,
   0<=OFFSET_{NWC}<=255
2. Calculate Accentuation Amount:

$${f}_{accen} ( MAX - MID ) = [ a * ( 1 - {ⅇ}^{( - b ( ( MAX - fnwc ) - MID ) / 255 )} ) ] * … [ - {( ( ( MAX - fnwc ) - MID ) / ( 255 * c ) )}^{d} + 1 ] * … [ - {( ( ( ( MAX - fnwc ) - MID ) / ( 255 * g ) ) - 1 )}^{h} + 1 ]$$
for f_{accen}>=0.0
3. Calculate MAX color Scale-Back Compensation:
   f_{sbc}(MAX_{org})=OFFSET_{sbc}+(1−OFFSET_{sbc})(255−MAX)/255
   Where,
   0<=OFFSET_{sbc}<=1.0
4. Calculate MAX_{new}:
   MAX_{new}=MAX+f_{accen}(MAX−MID)*f_{sbc}(MAX)*MAX
5. The total equation can be calculated as:

$$\begin{matrix}{MAX}_{NEW} = MAX * [ a * ( 1 - {ⅇ}^{( - b ( ( MAX - [ ( MIN / 255 ) * {OFFSET}_{NWC} ] ) - MID ) / 255 )} ) ] * \\ … [ - ( ( ( MAX - [ ( MIN / 255 ) * {OFFSET}_{NWC} ] ) - MID ) / \\ { ( 255 * c ) )}^{d} + 1 ] * … [ - ( ( ( ( MAX - [ ( MIN / 255 ) * \\ { {OFFSET}_{NWC} ] ) - MID ) / ( 255 * g ) ) - 1 )}^{h} + 1 ] * … \\ [ {OFFSET}_{sbc} + ( 1 - {OFFSET}_{sbc} ) ( 255 - MAX ) / 255 ] + … MAX\end{matrix}$$
6. The last step would be to calculate the Brightness Compensation, using equations (m), (n), and (o).

The technique of Color Accentuation can be combined with other image enhancement techniques when applied to a subject image or video or film frame. One example is the use of histogram equalization. This technique, which is well known in the art, expands the dynamic range of pixel values in an image by an adaptive process. The probability function of pixel values for a given image is calculated and then a pixel mapping function derived from that function which, when applied to each pixel, improves the contrast and dynamic range of the image. One object of the present invention is to combine Color Accentuation and histogram equalization by either first enhancing the contrast of the image using histogram equalization and then applying Color Accentuation or by first applying Color Accentuation and then applying histogram equalization.

A typical histogram equalization method is described in Digital Image Processing, Gonzalez & Woods, Prentice Hall, © 2002, Chapter 3.3.1, which is incorporated here by reference. In the application to a color image, the color image is first transformed to a grey-scale image. This is typically done by calculating a grey scale value equal to a linear combination of the R, G, and B values for each pixel. In the preferred embodiment, the coefficients for R, G and B, respectively, are (0.3, 0.5, 0.2). The object of the histogram process is to calculate a unique transfer function T that maps an input grey scale level from the original image to an output level grey scale level.

One of the problems faced by the method described by Gonzalez & Wood is that the transform function T, maps the original grey scale values ranging from 0 to 255 to a set of new grey scale values, in a one to one mapping to another set of values from 0 to 255. The result is that in cases where only a few grey scale values describe a gradient and that gradient is subject to increased contrast, the gradient is still represented by the same number of different grey scale values even though the new grey scale values may have a wider range. The net result is banding, which is esthetically unacceptable.

One object of the invention is to avoid the banding. One way the invention does this is as follows: the grey scale image is encoded to encompass more than 255 levels of grey scale. This is accomplished at the conversion step described above. Each grey scale calculation is then
(((m_weightRed*R)+(m_weightBlue*B)+(m_weightGreen*G))/((m_weightRed+m_weightBlue+m_weightGreen)/(GREYSCALE_LEVELS/255)),

Where the m_weight values are the coefficients described above and GREYSCALE_LEVELS is the number of different grey scales minus one. In the preferred embodiment, the number of grey scale levels is 1023 By this means, the banding problem is reduced considerably.

Another problem with typical histogram equalization methods is that the transfer function T produces a result that is too extreme and therefore impractical. It is a further object of the invention to control the transfer function T so that the results are appropriate for photographs. The transfer function T can be modified as follows:

For each input grey scale value in I, where I is the set of integers from 0 to GREYSCALE LEVELS, T produces an output grey scale value from the input gray scale values in I, ranging from 0 to GREYSCALE LEVELS, this set denoted as O. Thus, if one calculates a function P=1+a*((T(I)−I)/I) for each input grey scale value in I, then the output grey scale value for each I is in the set O=I*P, where a is a constant scaling factor that controls the amount of histogram equalization that is applied. The special case where I=0 is handled separately by mapping I=0 to O=0. If a=0, there is no histogram contrast enhancement, and when A=1, it is full on. The output gray scale value may also be expressed as O=I+a*(T(I)−I). In the preferred embodiment, a is equal to 0.2.

A further problem with histogram equalization is that it can introduce artifacts into an image in certain circumstances. To avoid this, the function P can be altered to be more of an autobrightness rather than a contrast enhancement. This is done by determining the average input grey scale value over I, referred to here as Avg(I), Then a shift is calculated by S=I−T(Avg(I)). Each value of shift S is the same across the values of I, and is added to each grey scale value of the input image I to shift the brightness of the image, that is, O=I+S. Brightness shift may also be modulated by multiplying a constant times S, so that 0=I+b*S, where b is a scaling factor that controls the magnitude of autobrightness effect. In the preferred embodiment, b=0.2.

The two approaches may be combined so that for each value in I, a shift in grey scale level O−I is calculated: for the brightness, it is b*S, and for the contrast enhancement using the histogram, it is a*(T(I)−I). Together, D=O−I=B*S+A*((T(I)−I). The same approach may be used separately for the contrast enhancement D=O−I=a*((T(I)−I) and the brightness D=O−I=b*S. The grey scale values are created by iterating through the pixels and calculating the input grey scale values. During this calculation, the histogram is calculated as described in Gonzalez & Wood. It is important to note that the denominator used to calculate T is the number of grey scale levels, not necessarily 255. The output grey scale values are calculated when iterating through the image a second time on a pixel by pixel basis, this time determining the amount of shift D for each pixel. D is divided by 3 (to allocate to R, G and B). This value (whether positive or negative) is first multiplied by the value 255 for GREYSCALE LEVELS and then added to the R, G and B value of the original color image. The multiplication renormalizes the value D from a grey scale range of 0 to GREYSCALE LEVELS to a range of 0 to 255. It should be noted that only the calculation of the gray scale values need to be calculated to determine the histogram. These values are used to adjust the components of the original color image. In other words, once the grey scale values have been calculated and the histogram determined, further use of the grey scale image is optional: either the grey scale values can be looked up in order to determine how to change the color components for the color output, or the grey scale values of the color pixels can be re-calculated in that step.

Practitioners of ordinary skill will recognize that the value D can be allocated to the values of R, G and B using the weighting or another function. The second iteration of the color image may occur during the same iteration through the color image where color accentuation is applied, thus saving compute time.

The present system is considered a color accentuation system, not a color correction system, although it is expected that this process can become a new kind of color correction. Color correction implies that the to be printed or displayed color is corrected to be identical to the original image. In many cases, the image taken has color flaws that depart from the original, or the intended original.

The present method or system has used the amplitude of the color components as the parameter to be measured and adjusted. Other parameters of the system may be used for the relative measures and adjustment. They could include any of color, hue, saturation, luminance, chrominance, focus or any other video control.

Although the present invention has been described and illustrated in detail, it is to be clearly understood that the same is by way of illustration and example only, and is not to be taken by way of limitation. The scope of the present invention are to be limited only by the terms of the appended.

1. A method of color adjustment of a digital image comprising:
determining, for at least one pixel in a color image, which of the color components of the pixel are, relative to each other, either the maximum and middle components for an additive space or the middle and minimum magnitudes for a subtractive space; and
adjusting the magnitude of either the maximum color component by a scaling function, whose argument includes the difference of the maximum and middle component magnitudes in an additive color space, or the magnitude of the minimum color component by a scaling function, whose argument includes the difference of the middle and minimum component's magnitudes in a subtractive color space;
wherein the absolute value of the scaling function initially increases from an initial value to a maximum value as the difference increases from its minimum to its maximum, whereby the maximum absolute value in the scaling function is reached when the value of the difference is less than its maximum range.

2. The method according to claim 1, wherein the absolute value of the scaling function initially increases from an initial value to a maximum value and finally decreases to a final value which is less than the maximum value.

3. The method according to claim 1, wherein the initial increase is between and extends over all or a portion of 0% to 50% of the range of the differences, the peak is between and extends over all or a portion of 0% to 80% of the difference range and the final decrease is between and extends over all or a portion of 40% to 100% of the difference range.

4. The method according to claim 1, wherein the initial increase is 20% to 40% of the total range of the differences, the peak is 25% to 35% of the total difference range and the final decrease is 20% to 25% of the total difference range.

5. The method according to claim 1, including determining the most dominant color component and next dominant color component in a group of pixels; adjusting the most dominant color component as a function of a comparison of the most dominant color component to the next dominant color component.

6. The method of claim 5, where the determining step is made by calculating a convolution on all neighboring pixels within a bound area.

7. The method of claim 6, wherein the convolution is calculated for a pixel located at point x,y in the image is calculated as:
$$Cx , y = {\sum }_{{x}^{′} = x - {x}_{0}}^{{x}^{′} = x + {x}_{0}} {\sum }_{{y}^{′} = y - {y}_{0}}^{{y}^{′} = y + {y}_{0}} \frac{\% MAX ( {x}^{′} , {y}^{′} )}{{( {( {x}^{′} - x )}^{2} + {( {y}^{′} - y )}^{2} )}^{N}}$$
where % MAX(x′,y′) is the value of the color component being analyzed at point (x′,y′) in the image, X₀,Y₀ are the dimensions of the region of convolution, and N is the selected sharpness of the convolution function.

8. The method according to claim 1, including after the magnitude adjusting, determining the brightness of the color components before and after the magnitude adjustment; and adjusting some of the color components as a function of the comparison of the before and after brightnesses.

9. A color accentuation method for a pixel of a digital color image comprising:
calculating either a new maximum color component value of the pixel as a function of the maximum color component for that pixel and the value of the same color component among a pre-determined number of local pixels for an additive color space or a new minimum color component value of the pixel as a function of the minimum color component for that pixel and the value of the same color component among a pre-determined number of local pixels for a subtractive color space;
calculating a scaling function using either the calculated new maximum color component value for the additive color space or the new minimum color component value for the subtractive color space; and
adjusting the value of either the new maximum color component for the additive color space or the new minimum color component value for the subtractive color space of the pixel by the amount of the scaling function.

10. A method of color adjustment of a digital image made up of pixels residing in a color signal processing system comprising:
increasing the saturation of at least one color component in at least one pixel whose position on a color wheel lies substantially within an annular ring around the center of the color wheel while not substantially increasing the saturation of said at least one color component for the pixel that lies outside the annular ring.

11. A method of color adjustment of a digital image made up of pixels encoded in a polar color space, residing in a color signal processing system comprising:
determining for at least one pixel in the image the difference of the amount of at least two of the set of red, green, blue and yellow by calculating a linear combination of at least two of the polar color components of said pixel.

12. A method of color adjustment of a digital image made up of pixels encoded in a polar color space, residing in a color signal processing system comprising:
determining for at least one pixel in the image, the maximum, middle and minimum amounts of three of the set of red, green, blue and yellow; and
adjusting the apparent intensity of at least one of the set of red, green, blue and yellow by calculating new values for the polar color components as a function of the difference between said maximum and middle amounts.

13. A method of color accentuation comprising:
determining, for at least one pixel in a color image, the relative magnitude of each color component of the pixel;
determining, for a subtractive color space, the difference of the magnitude of a middle color component to a lowest color component and, for an additive color space, the difference of the magnitude of a highest color component to a middle color component; and
selecting and adjusting the magnitude of one or more of the color components of the pixel by an amount that is a function of the determined difference of the middle color component to the lowest color component for the subtractive color space and a degree of whiteness and is a function of the determined difference of the highest color component to the middle color component for the additive color space and a degree of whiteness.

14. A system for receiving input signal for an image to be displayed in color, the system including a signal processor and wherein the signal processor:
receives or derives color components of a pixel from the input signals;
determines for a subtractive or an additive color space the relative magnitude of each color component of the pixel;
determines, for the subtractive color space, the difference of the magnitude of a middle color component to a lowest color component and, for the additive color space, the difference of the magnitude of a highest color component to a middle color component; and
selects and adjusts the magnitude of one or more of the color components as a function of the determined difference of the middle color component to the lowest color component for the subtractive color space and a degree of whiteness and as a function of the determined difference of the highest color component to the middle color component for the additive color space and a degree of whiteness.

15. A method of color accentuation of a color image made up of areas, encoded in a color space, the method comprising:
detecting in each area the magnitude of each color component of the color space; and
adjusting the magnitude of color components in each area in accordance with a scaling function applied to the detected color components to increase the difference between a maximum and a minimum color component in each area, the scaling function being based on a difference of a middle color component to the lowest color component for a subtractive color space and a degree of whiteness or on a difference of the highest color component to the middle color component for an additive color space and a degree of whiteness for each area.

16. A color accentuation method for a pixel comprising:
calculating a maximum color component value of the pixel as a function of the maximum color component for that pixel and the value of the same color component among a pre-determined number of local pixels;
calculating a scaling function using the calculated maximum color component value; and
adjusting the value of the color component of the pixel by the amount of the scaling function.

17. A method of color accentuation comprising:
determining, for at least one pixel in a color image, the relative magnitude of each color component of the pixel;
determining, for a subtractive color space, the difference of the magnitude of a middle color component to a lowest color component and, for an additive color space, the difference of the magnitude of a highest color component to a middle color component; and
selecting and adjusting the magnitude of one or more of the color components of the pixel by an amount that is a function of the determined difference of the middle color component to the lowest color component for the subtractive color space and the value of the lowest color component and is a function of the determined difference of the highest color component to the middle color component for the additive color space and the value of the highest color component.

18. A method of color accentuation comprising:
determining, for at least one pixel in a color image, the relative magnitude of each color component of the pixel;
determining, for a subtractive color space, the difference of the magnitude of a middle color component to a lowest color component and, for an additive color space, the difference of the magnitude of a highest color component to a middle color component; and
selecting and adjusting the magnitudes of the lowest and middle color components of the pixel by an amount that is a function of the determined difference of the middle color component to the lowest color component for the subtractive color space and the magnitudes of the highest and middle color components of the pixel by an amount that is a function of the determined difference of the highest color component to the middle color component for the additive color space.

19. A method of color accentuation comprising:
determining, for at least one pixel in a color image, the relative magnitude of each color component of the pixel;
determining, for a subtractive color space, the difference of the magnitude of a middle color component to a lowest color component and, for an additive color space, the difference of the magnitude of a highest color component to a middle color component;
selecting and adjusting the magnitude of one or more of the color components of the pixel by an amount that is a function of the determined difference of the middle color component to the lowest color component for the subtractive color space and is a function of the determined difference of the highest color component to the middle color component for the additive color space; and
equalizing the pixels in the image using histogram equalization at least once during the method.

20. A method of contrast enhancement of a color image comprising:
transforming the color components of the color image into a set of gray scale levels, the magnitude of the color components have one of a first number of values and the gray scale levels have one of a second number of values substantially greater than the first number of values;
enhancing the pixels in the image using histogram equalization of the gray scale image.

21. A method of contrast enhancement of a color image comprising:
transforming the color components of the color image into a gray scale image;
selecting a scaling factor which determines the amount of equalization; and
enhancing pixels of the color image using histogram equalization of the gray scale image using the selected scaling factor.
